(19) United States
(12) Patent Application Publication
(10) Pub. No.: US 2017/0191298 A1
(43) Pub. Date: Jul. 6, 2017

(54) ELECTRONIC CIRCUIT FOR SAFELY CLOSING A MOTOR-DRIVEN DOOR OF A RAIL VEHICLE

(71) Applicant: KNORR-BREMSE GESELLSCHAFT MIT BESCHRÄNKTER HAFTUNG, Mödling (AT)

(72) Inventor: Andreas MAIR, Oberschlierbach (AT)

(21) Appl. No.: 15/313,256

(22) PCT Filed: May 21, 2015
(86) PCT No.: PCT/EP2015/061296

§ 371 Date: Nov. 22, 2016

(30) Foreign Application Priority Data
May 22, 2014 (AT) A 50366/2014

(51) Int. Cl. E05F 5/02; B61D 19/02; E05F 15/659; H02P 3/12; H02P 7/08

(52) U.S. Cl. CPC E05F 5/02; H02P 3/12; H02P 7/08; E05F 15/659; B61D 19/02; E05Y 2201/25; E05Y 2201/434; E05Y 2400/31; E05Y 2400/45; E05Y 2900/51

(57) ABSTRACT

The disclosed embodiments relate to an electronic circuit for a motor-driven door of a rail vehicle, said electronic circuit having a series circuit of a first non-linear element and a first controllable switch between the motor terminals. The first non-linear element is poled such that the resistance thereof to a current generated by the drive motor during a closing movement of the door is greater than during an opening movement. If a supply voltage for the door is present, the resistance of the first switch is effected relative to the resistance when said supply voltage is absent. The invention further relates to a door module for a rail vehicle having such an electronic circuit, to a rail vehicle for such a door module, and to a use of the electronic circuit.

### CROSS REFERENCE AND PRIORITY

Priority Paragraph

This patent application is a U.S. National Phase of International Patent Application No. PCT/EP2015061296, filed May 21, 2015, which claims priority to Austrian Patent Application No. A 50366/2014, filed May 22, 2014, the disclosure of which are incorporated herein by reference in their entirety.

### FIELD

Disclosed embodiments relate to an electronic circuit for a motor-driven door of a rail vehicle, comprising motor connections for a drive motor of the door and supply connections for a supply voltage for the drive motor. Furthermore, the disclosed embodiments relate to a door module for a rail vehicle, comprising a door and a drive motor for the door and also an electronic circuit of the type cited above that is connected to the drive motor. The disclosed embodiments also relate to a rail vehicle having an electrical supply line and to a door module of the cited type that is connected to the supply line. Finally, the disclosed embodiments relates to the use of an electronic circuit of this kind in a door module of a rail vehicle.

### BACKGROUND

An electronic circuit, a door module and a rail vehicle of the type cited above are known in principle. Generally, the drive motors of the door modules are used for conveniently opening and closing the doors, which sometimes have considerable inherent weight and can therefore be moved only with difficulty manually (the admissible sliding forces are frequently even defined in standards). Furthermore, safety engineering aspects are also significant, since the motorized doors are normally also controllable from a central position. By way of example, the doors can be opened, closed, unlocked and locked from the driver's cab of the rail vehicle. For safety reasons, the doors are generally also operable manually, however. That is to say that the door can be opened or closed by hand by pulling/pushing a door handle. This does not just concern the case in which the rail vehicle is in operation, but particularly also concerns the case in which the rail vehicle is out of operation. By way of example, it may be switched off and isolated from the electrical supply system. The rail vehicles are often also isolated from the electrical supply system for initial fitting, commissioning and for maintenance.

Frequently, in a rail vehicle, door modules are encountered whose door leaves are locked not by a catch or a bolt but rather with the aid of an over-center locking system. In a manner that is known per se, the door leaf is held in an over-center area in this case, so that the doors cannot spring open without external influence.

Particularly when the door is closed energetically, the case can arise, without further measures, in which the door, after reaching the closed position, recoils to the open position again. This may be caused by elastic deformation of the door mechanism, of the door leaf or of another resilient element, for example. Sometimes, this behavior is misinterpreted by the person operating the door, and the door is then slammed even harder, which understandably cannot result in success, however, since the door will recoil from the closed position again even more strongly. Particularly with people who are ready to use violence and/or are aggressive, the springing open of the door can also prompt or promote further acts of vandalism.

The prior art discloses the practice of solving this problem by providing mechanical shock absorbers and the like. The problem in this case, however, is correct adjustment, particularly with regard to aging phenomena and different behavior in the event of temperature fluctuations. In practice, it is therefore frequently the case that the shock absorbers are not adjusted in optimum fashion or are subject to constant alignment efforts and do not or only inadequately solve the cited problem.

It is therefore an object of the disclosed embodiments to specify an improved electronic circuit, an improved door module and an improved rail vehicle. In particular, the aim is to effectively prevent a door of a rail vehicle from inadvertently springing open when operated manually and in the absence of a supply voltage.

### SUMMARY

The object of the disclosed embodiments is achieved with an electronic circuit of the type cited at the outset, additionally having a first path connecting the motor connections, comprising a first nonlinear element and a first controllable switch connected in series therewith, wherein the first nonlinear element is poled such that the resistance of the element to a current that the drive motor produces by way of a generator for a closing movement of the door (5) is higher than for an opening movement, and a first partial circuit, comprising the supply connections and connected to a control input of the first switch, that prompts an increase in the resistance of the first switch when the supply voltage is present in comparison with the resistance when the supply voltage is absent.

That is to say that the switch is essentially open when the supply voltage is present and is essentially closed when it is absent.

The object of the is also achieved with a door module of the type cited at the outset that additionally comprises an electronic circuit of this kind connected to the drive motor.

Furthermore, the disclosed embodiments is achieved with a rail vehicle of the type cited at the outset that additionally comprises a door module of this kind connected to the supply line.

Finally, the object of the disclosed embodiments is also achieved by the use of an electronic circuit of the cited type in a door module of a rail vehicle.

Generally, the switch used may be embodied as a relay or as a transistor, for example. Particularly when it is embodied as a transistor, it is noted at this juncture that the transistor does not have to be used purely as a switch, but rather it is also possible to use the function of the transistor as a controllable resistor. Nevertheless, within the context of the disclosed embodiments, the term “switch” is retained, but with the proviso that this term is intended to be understood in a broad sense and hence also includes variable resistors. This is not least because the resistance of the transistor, even when used as a switch, changes from one value to another not abruptly but rather steadily.

The electronic circuit is used to solve the problem of the disclosed embodiments without the assistance of mechanical shock absorbers. To this end, the first switch is closed when the rail vehicle is switched off and when the supply voltage disappears. This results in the drive motor being essentially shorted for a movement in the direction of opening of the door. In the direction of closing, the motor connections can be regarded as open, on the other hand, on account of the reverse-biased diode. This means that the door can be closed with comparatively little effort. As soon as it springs back from the closed position, however, the polarity of the voltage that the drive motor of the door module produces by way of a generator changes, which results in a current in the forward direction of the diode. The current, or the back electromotive force (back EMF) brought about thereby, opposes the opening movement with considerable resistance, so that the door does not overcome the dead center of the over-center locking system in the direction of opening, even when slammed in such a violent manner, and hence remains safely in the closed position. This prevents an escalation by a user, who can no longer misinterpret the behavior of the door.

At this juncture, it is noted that the electronic circuit presented is effective only when the supply voltage disappears. When the supply voltage is applied, the first partial circuit ensures that the switch is opened and the door can be moved “normally” by the drive motor. This is normally accomplished by using dedicated control, which is known per se, however, and therefore is not explained further.

In addition, it is noted that the use of the electronic circuit does not preclude the use of additional shock absorbers of a different design. By way of example, in addition to the electronic circuit, it is also possible to use hydraulic and/or mechanical shock absorbers.

Further advantageous refinements and developments of the disclosed embodiments are obtained from the subclaims and from the description in combination with the figures.

It is favorable if the first switch has a linear element or a resistor arranged in parallel with it. The resistor can stipulate a minimum braking effect of the motor in the direction of opening of the door. The door therefore also cannot be thrown excessively energetically against the end stop in the direction of opening.

It is additionally favorable if the electronic circuit has a path that is parallel to the first path and in which a linear element or a resistor is arranged. This allows excessively energetic closing of the door to be prevented by permitting a defined flow of current into the motor windings and hence building up a defined mechanical resistance to closing by the door system. An advantage in this case is that the mechanical resistance becomes higher the faster the door is moved, since the voltage that the motor produces by way of a generator rises as rotation speed rises, of course. The behavior of the circuit is thus like that of a progressive shock absorber when the door is closed.

It is furthermore favorable if the electronic circuit has a path that is parallel to the first path and in which a second nonlinear element is connected in antiparallel with the first nonlinear element. In this way, the aforementioned resistance is effective exclusively during the closing movement of the door.

It is favorable if the path that is parallel to the first path has a second controllable switch arranged in it and if the first partial circuit is connected to a control input of the second switch and prompts an increase in the resistance of the second switch when the supply voltage is present in comparison with the resistance when the supply voltage is absent. That is to say that the second switch is opened (in sync with the first switch) when the supply voltage is present and is closed when it disappears. This prevents the aforementioned resistance from impeding the movement of the door by the motor during normal operation, or a current caused by the supply voltage from flowing via the resistor.

It is additionally favorable if the first partial circuit comprises a DC isolating element that has its input side connected to the supply connections and has its output side connected to the control input of the first switch and—if present—to the control input of the second switch. This provides DC isolation for the electronic circuit from the power supply system of the rail vehicle. The DC isolating element used may be an optocoupler, a transformer or a relay, for example.

It is furthermore favorable if the resistance acting in the first path and/or the path that is parallel thereto in the direction of opening and/or in the direction of closing of the door is adjustable. This allows the damping effect of the electronic circuit to be adapted on an individual basis.

It is particularly advantageous if the electronic circuit has a second partial circuit that actuates the first switch such that the resistance of the switch immediately after the current turns from the closing movement of the door to the opening movement of the door is lower than afterwards. As a result, the braking effect of the motor immediately after the door recoils is particularly great. This effectively prevents the door from inadvertently springing open, yet deliberate opening of the door is not countered by excessively high resistance, which is particularly also advantageous in the event of emergency operation.

It is also advantageous in the above context if the second partial circuit comprises a timer acting directly or indirectly on the control input of the first switch. This allows the temporal limiting of the aforementioned intensified resistance to springing open again to be implemented using simple means. By way of example, the timer may be in the form of an RC element. Alternatively, it is naturally also possible to use other timers, for example (crystal stabilized) digital timers.

It is additionally particularly advantageous if the electronic circuit comprises a third partial circuit that bypasses the first switch and/or actuates it such that the resistance of the switch is lowered when an opening movement of the door occurs for a long time or frequently in an interval of time. If the door is repeatedly opened and closed with great force and hence quickly and/or in quick succession, as may be the case with an act of vandalism, for example, the electronic circuit is subjected to very high load. To prevent (thermal) destruction, the frequency or intensity of the movement of the door is monitored by the third partial circuit, and the first switch is closed if need be. If this case arises, barely any further voltage is dropped across the first switch, which means that the power loss and hence the thermal loading are also low. Alternatively or additionally, the first switch can also be bypassed with a (further) switch to reduce the thermal loading. It is particularly advantageous in this case if the further switch is a field effect transistor optimized for switching tasks that has very low resistance in the on state. Particularly with this design, the first switch may be in the form of a linear transistor, which means that control of a defined mechanical resistance to excessive movement of the door is particularly successful.

It is alternatively particularly advantageous if the electronic circuit comprises a third partial circuit that bypasses the first switch and/or actuates it such that the resistance of the switch is lowered for a rising temperature of the first switch. In this variant, the temperature of the first switch is ascertained directly to switch it on if need be and hence to reduce the thermal loading of the switch. The aforementioned embodiment with an alternative or further bypassing switch can also be used mutatis mutandis in this variant.

Finally, it is also favorable for a door module according to the disclosed embodiments if, instead of the first nonlinear element, a linear element is provided. This results in a particularly simple electronic circuit.

### BRIEF DESCRIPTION OF FIGURES

Disclosed embodiments is explained in greater detail below with reference to the drawings, in which:

FIG. 1 shows a first example of an electronic circuit for safely closing a motor-driven door of a rail vehicle;

FIG. 2 shows an exemplary door module of a rail vehicle;

FIG. 3 shows an exemplary rail vehicle with the door modules from FIG. 2;

FIG. 4 is similar to FIG. 1, just with a resistance that is effective when the door is closed;

FIG. 5 is similar to FIG. 5, just with an additional diode in the parallel path;

FIG. 6 is similar to FIG. 5, just with an additional switch in the parallel path;

FIG. 7 is similar to FIG. 1, just with a resistance that is effective when the door is opened;

FIG. 8 is similar to FIG. 7, just with an antiparallel path;

FIG. 9 shows a somewhat more detailed embodiment of an electronic circuit for safely closing a motor-driven door of a rail vehicle;

FIG. 10 is similar to FIG. 9, just with a switch bypassing the first switch, and

FIG. 11 is similar to FIG. 10, just with a third partial circuit, which evaluates the frequency and intensity of a door movement.

### DETAILED DESCRIPTION

By way of introduction, it will be stated that like parts in the differently described embodiments are provided with like reference symbols or like component designations, the disclosures contained throughout the description being able to be transferred mutatis mutandis to like parts with like reference symbols or like component designations. The indications of position that are chosen in the description, such as e.g. top, bottom, side, etc. also refer to the figure that is immediately described and presented and, on a change of position, can be transferred to the new position mutatis mutandis. Additionally, individual features or combinations of features from the different exemplary embodiments shown and described may also be independent, inventive or disclosed embodiments-based solutions.

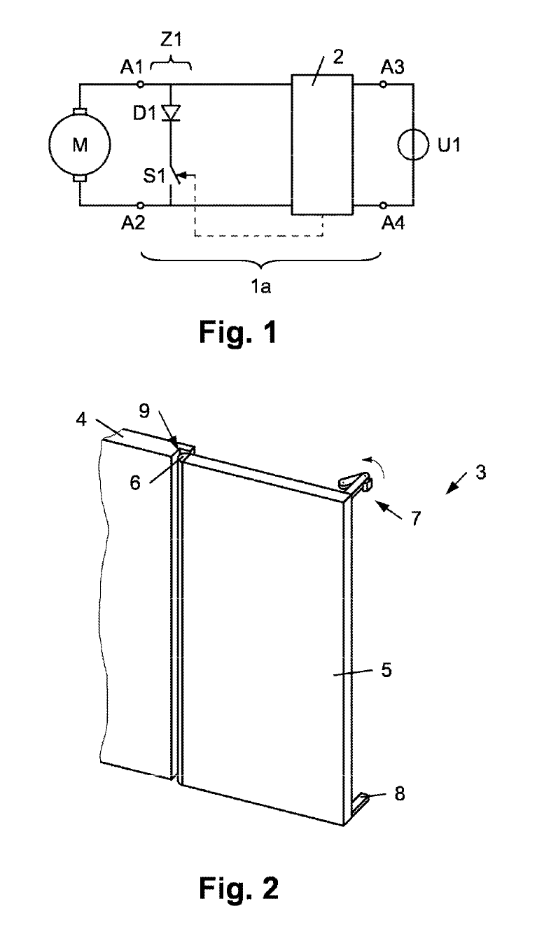

FIG. 1 shows a first example of an electronic circuit 1a for a motor-driven door of a rail vehicle. The circuit 1a comprises motor connections A1, A2 for a drive motor M of the door and supply connections A3, A4 for a supply voltage U1 for the drive motor M. The circuit 1a additionally has a first path Z1, connecting the motor connections A1, A2, that comprises a first nonlinear element D1 and a first controllable switch S1 connected in series therewith, wherein the first nonlinear element D1 is poled such that the resistance of the element to a current that the drive motor M produces by way of a generator for a closing movement of the door is higher than for an opening movement. In FIG. 1, the nonlinear element is formed by a diode D1 that is off for the closing movement of the door and is on for the opening movement. Finally, the electronic circuit 1a comprises a first partial circuit 2, comprising the supply connections A3, A4 and connected to a control input of the first switch S1, that prompts an increase in the resistance of the first switch S1 when the supply voltage U1 is present in comparison with the resistance when the supply voltage is absent. Specifically, the first switch S1 in FIG. 1 is essentially open when the supply voltage U1 is present and is essentially closed when it is absent.

FIG. 2 shows an exemplary door module 3 that is in the form of a pivoting/sliding door module and is fitted in a wall 4 of a rail vehicle. The pivoting/sliding door module 3 comprises a door leaf 5 having a seal 6, an over-center locking system 7 and a guide lever 8. To drive the door leaf 5, a motor M, not shown, is provided. By way of example, this may be linked to the over-center locking system 7 or in another manner that is known per se.

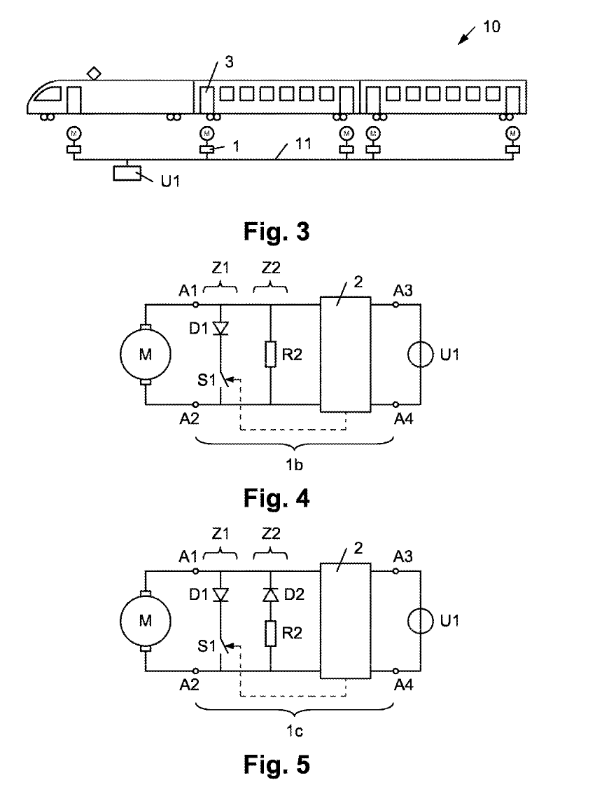

FIG. 3 now shows an exemplary rail vehicle 10 that has a series of door modules 3. The door modules 3 are designed as shown in FIG. 2, for example, and each have an electronic circuit 1. A voltage source U1 and a supply line 11 are used to supply the drive motors M of the door modules 3 with electric power. By way of example, these are opened and closed from the driver's cab of the rail vehicle 10 in a manner that is known per se.

The operation of the electronic circuit 1 will now be explained in more detail with reference to FIGS. 1 to 3, assuming a situation according to which the rail vehicle 10 and also the power supply 11 are switched off. In this situation, the doors 5 are not openable or closable by a motor centrally from the driver's cab of the rail vehicle 10. Simply for safety reasons, the doors continue to be manually operable, however. That is to say that the door 5 can be opened or closed by hand by pulling/pushing a door handle.

The door 5 shown in FIG. 2 is generally not necessarily locked by a catch or a bolt, but rather remains inherently locked by the over-center locking system without further measures. In this case, the door seal 6, which bears against the door rebate 9, pushes the door leaf 5 or the mobile lever of the over-center locking system 7 against a stop fixed to the vehicle.

Particularly when the door 5 is closed (excessively energetically), the case can arise, without further measures, in which the door 5, after reaching the closed position, recoils to the open position again. This can occur on account of the law of energy conservation or law of momentum conservation, for example by virtue of elastic deformation of the door mechanism, of the door leaf 5 or of a door seal (not shown in FIG. 2) arranged on the right-hand side of the door leaf 5. Sometimes, this behavior is misinterpreted by the person operating the door 5, and the door 5 is then slammed even harder, which understandably cannot result in success, however. Particularly with people who are ready to use violence and/or are aggressive, the springing open of the door can also prompt or promote further acts of vandalism. The prior art discloses providing mechanical shock absorbers and the like for this purpose. The problem in this case, however, is correct adjustment, particularly with regard to aging phenomena and different behavior in the event of temperature fluctuations.

The electronic circuit 1, 1a is used to solve this problem without the (mandatory) assistance of mechanical shock absorbers. Specifically, this is achieved by closing the first switch S1 when the rail vehicle 10 is switched off and when the supply voltage U1 disappears. This results in the motor M being essentially shorted for a movement in the direction of opening of the door 5. In the direction of closing, the motor connections A1 and A2 can be regarded as open, on the other hand, on account of the diode D1. This means that the door 5 can be closed with comparatively little effort. As soon as it springs back from the closed position, however, the voltage that the motor M produces by way of a generator changes, the voltage now resulting in a current in the forward direction of the diode D1. The current, or the back electromotive force (back EMF) brought about thereby, opposes the opening movement with considerable resistance, so that the door 5 does not overcome the dead center of the over-center locking system 7 in the direction of opening, even when slammed in such a violent manner, and hence remains safely in the closed position. This prevents an escalation by a user, who can no longer misinterpret the behavior of the door 5.

At this juncture, it is noted that the electronic circuit 1a is effective only when the supply voltage U1 disappears. When the supply voltage U1 is applied, the first partial circuit 2 ensures that the switch S1 is opened and the door 5 can be moved “normally” by the motor M. This is normally accomplished by using dedicated control, which is known per se, however, and therefore is not shown in the figures.

FIG. 4 now shows a variant of the electronic circuit 1b, which is very similar to the circuit 1a shown in FIG. 1. By contrast, a resistor R2 is arranged in a path Z2 parallel to the series circuit Z1. The resistor R2 is effective both for the closing movement and for the opening movement of the door 5, but essentially only for the closing movement on account of the virtual short in Z1. The resistor R2 can be used to prevent excessively energetic closing of the door 5 by virtue of a defined resistance to closing being built up via the motor M or via the resistor R2 and hence the current flowing through the motor windings. An advantage in this case is that this resistance becomes higher the faster the door 5 is moved. The behavior of the circuit 1b is thus similar to that of a progressive shock absorber when the door is closed.

FIG. 5 now shows a variant of an electronic circuit 1c, which is very similar to the circuit 1b shown in FIG. 4. By contrast, a path Z2 parallel to the series circuit Z1 is provided in which a second nonlinear element D2, specifically a second diode D2, is connected in antiparallel with the first diode D1. In this way, the resistor R2 is effective exclusively for the closing movement of the door 5.

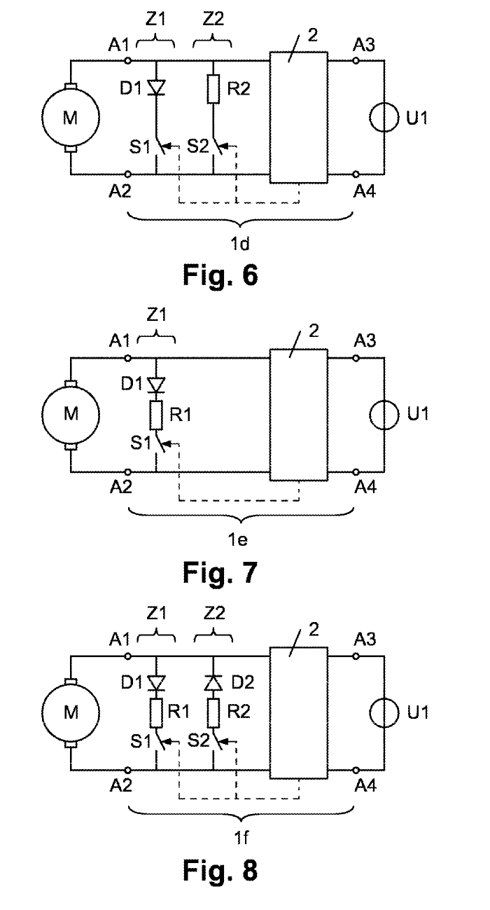

FIG. 6 shows a further variant of an electronic circuit 1d, which is very similar to the circuit 1b shown in FIG. 4. By contrast, however, the path Z2 parallel to the series circuit Z1 has a second controllable switch S2 arranged in it whose control input is connected to the first partial circuit 2. The first partial circuit again prompts an increase in the resistance of the second switch S2 when the supply voltage U1 is present in comparison with the resistance when the supply voltage is absent. That is to say that the second switch S2 is opened (in sync with the first switch S1) when the supply voltage U1 disappears and is closed when it is present. This prevents the resistor R2 from impeding the movement of the door 5 by the motor 5 during normal operation, or a current caused by the supply voltage U1 from flowing via the resistor R2.

FIG. 7 shows a further variant of an electronic circuit 1e, which is very similar to the circuit 1a shown in FIG. 1. By contrast, however, the first path Z1 has a resistor R1 provided in it that limits the current induced when the door 5 is opened, and hence the resistance opposing the opening movement of the door.

Finally, FIG. 8 shows a variant of an electronic circuit if in which the current flowing through the motor M is limited by the resistor R2 when the door 5 is closed and by the resistor R1 when the door 5 is opened. To this end, the paths Z1 and Z2 each have a diode D1, D2, a resistor R1, R2 and a switch S1, S2 connected in series in them, the diodes D1 being poled in antiparallel.

In general, there may be provision for the electronic circuit 1a . . . 1f to be coupled to an emergency operating facility. By way of example, this is accomplished by virtue of the path Z1 having a (further) switch provided in it in series with the switch S1, which is opened when the emergency operating facility is operated. This prevents opening of the door 5 in an emergency from being opposed by excessive mechanical resistance. Instead, the open additional switch ensures that the motor M is not braked in this operating state. In principle, such an additional switch can also be dispensed with, however, if the resistor R1 is of appropriate dimensions (in terms of magnitude) and excessive mechanical resistance to the opening of the door 5 is not built up anyway.

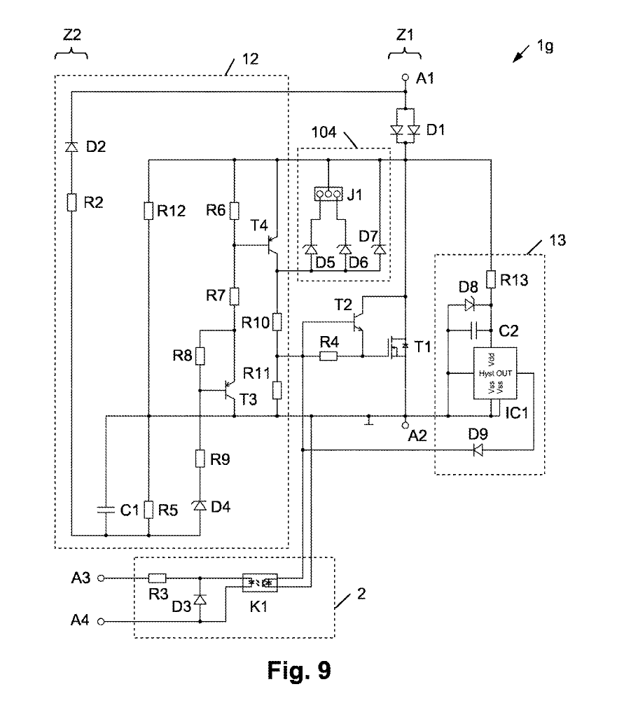

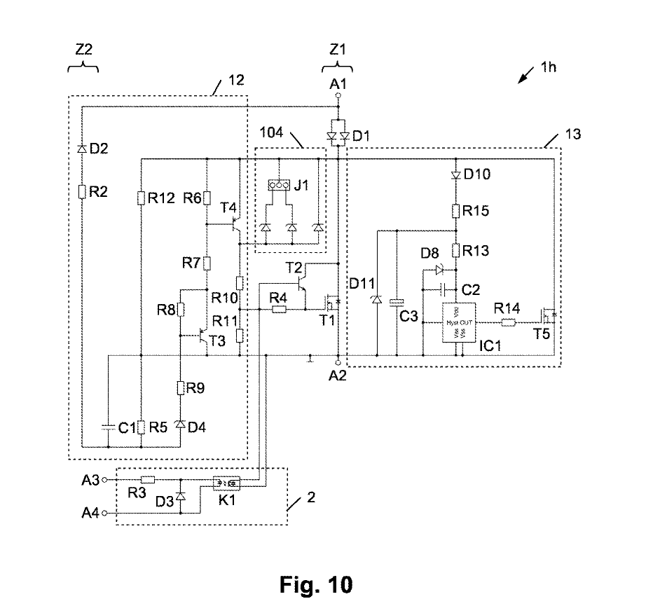

FIG. 9 now shows a somewhat more detailed embodiment of an electronic circuit 1g that has a similar basic structure to that of the electronic circuit 1c shown in FIG. 5. In this case, however, the switch S1 is formed by the transistor T1 or by Darlington connection of the transistors T1 and T2. The optional resistor R4 brings about limiting of the gate current of the transistor T1 in this case. For the purpose of increased current loading, the diode D1 is also formed by two single diodes in this case.

In this example, the first partial circuit 2 comprises an optocoupler K1, the input side of which is connected to the supply connections A3, A4 and the output side of which is connected to the control input of the first switch S1, specifically to the base of the transistor T2. To limit the current through the optocoupler K1, the resistor R3 is provided. The diode D3 is used as a protection diode against polarity reversal and/or overvoltage. When the supply voltage U1 is applied, the base of transistor T2 and hence the gate of transistor T1 are pulled to ground, which turns off the transistor T1. This corresponds to an open switch S1 or a high resistance. Instead of the optocoupler K1, it is naturally also possible to use another DC isolating element, for example a relay.

The electronic circuit 1g also comprises a second partial circuit 12 that actuates the first transistor T1 such that the resistance of the transistor immediately after the current turns from the closing movement of the door 5 to the opening movement of the door is lower than afterwards. To this end, the second partial circuit 12 has, in this example, a timer that acts on the control input of the first transistor T1 and that, in this example, is specifically in the form of an RC element and comprises the resistors R2, R5 and the capacitor C1.

In the example shown in FIG. 9, the RC element acts indirectly on the control input of the first transistor T1, but there could also be provision for the RC element to act directly on the control input of the first transistor T1. In addition, it is naturally also conceivable to use another timer, particularly to use a digital timer. The combination of an RC element with a threshold value switch, the output of which acts on the control input of the first transistor T1, would also be conceivable, of course.

For the closing movement of the door 5, the second path Z2 is turned on, that is to say that the potential on the motor connection A1 is lower than on the motor connection A2. The current flowing via the second path Z2 in this state is used to charge the capacitor C1.

When the door 5 reaches the closed position and recoils, the changed direction of movement means that there is also a change in the voltage on the motor M. The potential on the motor connection A1 is then higher than on the motor connection A2, and hence the first path Z1 is turned on. A current flows via the resistors R6, R7, R8, R9 and the zener diode D4 to the negative potential on the capacitor C1, which discharges slowly via the resistor R5. Hence, the base of transistor T3 has a voltage that rises from a low starting point applied to it, and the transistor T3 turns off rapidly. As a result, the base of transistor T4 also has a voltage that rises from a low starting point applied to it. The transistor T4 therefore likewise turns off rapidly, as a result of which the potential on the base of the transistor T2 is pulled down via the resistors R10 and R11. Consequently, the transistor T1 is also turned on gradually less and less.

The effect that can be achieved through appropriate dimensioning of the second partial circuit 12 is that activation of the partial circuit, that is to say a distinct braking effect in the direction of opening, requires firstly a particular minimum speed when the door 5 is closed, but secondly also a change in the direction of movement and hence in the voltage in a certain interval of time. This prevents an excessive braking effect from the electronic circuit 1g even for “normal” closing of the door 5.

At this juncture, it is noted that the transistor T1 is not used or does not have to be used purely as a switch. The transistor T1 can also be used as a controllable resistor, so that a separate resistor in the path Z1, as shown in FIGS. 7 and 8, can also be dispensed with.

The fall in conductivity of the transistor T1 means that there is also a fall in the braking effect of the motor M, which braking effect starts from a high value and heads for a value defined essentially by the resistor R12. When the transistor T1 is off completely, the motor current flows essentially through the resistor R12. The resistor R12 can thus stipulate a minimum braking effect for the motor M in the direction of opening of the door 5.

In addition, the resistance effective in the direction of opening of the door 5 in the first series circuit Z1 is adjustable in this example. To this end, the three zener diodes D5 . . . D7 and the jumper J1 are provided. This allows the potential on the base of the transistor T2 and hence the blocking action of the transistor T1 likewise to be influenced. In particular, the zener diodes D5 . . . D7 and the jumper J1 can be used to stimulate the potential on the base of the transistor T2 even when transistor T4 is essentially completely off. It goes without saying that similar adjustment options can also be provided for the direction of closing of the door 5 in the second path Z2.

As a result of the proposed measures, the motor M opposes a movement of the door leaf 5 both in the direction of opening and in the direction of closing with a defined resistance. Particularly on account of the progressive effect, a certain speed of the door leaf cannot be exceeded even with great effort, which avoids high mechanical loads when the end positions of the door 5 are reached.

This more or less steady-state resistance has an additional temporary resistance superimposed on it when the direction of movement changes from the direction of closing to the direction of opening. This additionally prevents the door from springing open again.

Finally, the electronic circuit 1g also comprises a third partial circuit 13 that actuates the first transistor T1 such that the resistance of the transistor is reduced when the temperature of the first transistor T1 rises. If the door 5 is repeatedly opened and closed with a high level of force and hence quickly and/or in quick succession, as may be the case with an act of vandalism, for example, the transistor T1 is subjected to a very high load. To prevent (thermal) destruction, the temperature of the transistor T1 is monitored by the third partial circuit 13. To this end, a temperature switch IC1 thermally coupled to the transistor T1 is routed to the input of the transistor T1 via the diode D9, as a result of which the transistor T1 is turned on when the temperature is too high. The very low resistance of the transistor T1 in the on state means that hardly any further voltage is dropped across it, so that the power loss and hence the thermal loading are then low.

In this state, the motor M is shorted during the whole opening movement of the door 5 in practice (and not just after it recoils from the closed position). That is to say that the door 5 can be opened only with difficulty in this state. This firstly protects the transistor T1, but secondly also deters vandals, since the door 5 is then barely movable. This state is maintained until the transistor T1 has cooled sufficiently for the (lower) switching threshold of the temperature switch IC1 to be reached. Consequently, a falling switching edge is output at the output of the temperature switch IC1, so that the transistor T1 is no longer actuated by the temperature switch IC1. The electronic circuit 1g is then in the normal operating state again. At this juncture, it is noted that the temperature switch IC1 has a switching hysteresis to avoid unwanted oscillation phenomena.

The thermal coupling between the transistor T1 and the temperature switch IC1 can be provided by virtue of the transistor T1 and the temperature switch IC1 being accommodated in the same housing and being arranged close to one another. By way of example, it is naturally also conceivable for the temperature switch IC1 to be linked directly to a cooling plate of the transistor T1.

In this example, the capacitor C2 serves as a blocking capacitor and is protected against overvoltage by means of the zener diode D8. The zener diode D8 is in turn protected against overcurrent by means of the resistor R13.

FIG. 10 shows an electronic circuit 1h that is very similar to the electronic circuit 1g. By contrast, however, the third partial circuit 13 is of somewhat different design. Instead of turning on the transistor T1 for an overtemperature, it is bypassed by means of the transistor T5 in this variant embodiment, the latter transistor being connected to the temperature switch IC1 via the resistor R14. It is particularly advantageous in this case if the transistor T5 is a field effect transistor optimized for switching tasks that has very low resistance in the on state. As a result, it barely heats up in the cited operating case, which means that the transistor T1 can be cooled effectively and without risk. In contrast to the transistor T5, the transistor T1 is embodied not as a switching transistor but rather as a linear transistor. As a result, control of a defined mechanical resistance to an excess movement of the door 5 is particularly successful in the normal temperature range.

In this example, the capacitor C3 serves as a backup capacitor and is protected against overvoltage by means of the zener diode D11. The zener diode D11 itself is protected against overcurrent by means of the resistor R15. The diode D10 ensures that the capacitor C3 is not emptied excessively quickly when the voltage turns, and serves as a rectifier diode as it were.

At this juncture, it is noted that the variant embodiments shown in FIGS. 9 and 10 can also be combined. This means that the connection routed via the diode D9 to the transistor T1 can also be provided in the embodiment shown in FIG. 10. In this way, the transistor T1 is not just bypassed but is also actively turned on.

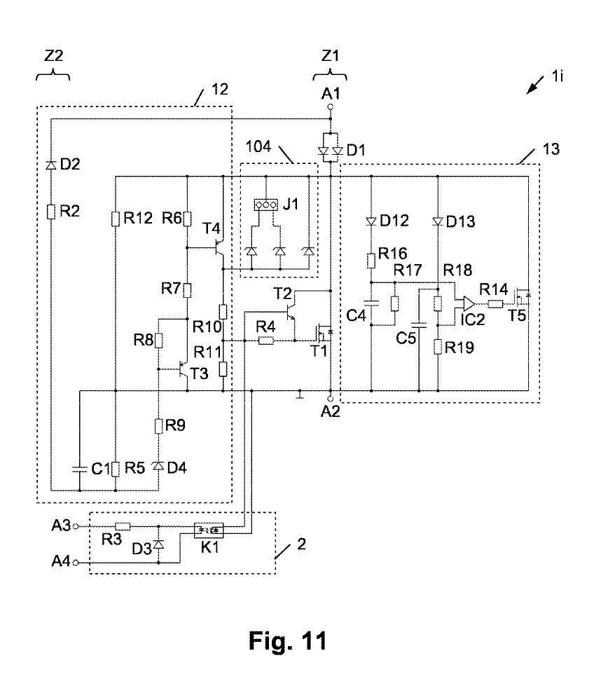

The third circuit part 13 shown in FIGS. 9 and 10 is not the only way of avoiding thermal overloading of the transistor T1. It is also conceivable for the third partial circuit 13 to bypass the first transistor T1 if an opening movement of the door 5 occurs for a long time or frequently in an interval of time. In this regard, FIG. 11 shows an electronic circuit 1i having a corresponding third partial circuit 13 that monitors the frequency or intensity of the movement of the door 5 to prevent (thermal) destruction of the transistor T1. The partial circuit comprises a threshold value switch IC2, the output side of which is connected to the transistor T5 via the resistor R14. Connected to the first (positive) input of the threshold value switch IC2 is a series circuit comprising two resistors R16 and R17 that is routed via a diode D12. The resistor R17 has a capacitor C4 provided in parallel with it. Connected to the second (negative) input of the threshold value switch IC2 is a series circuit comprising two resistors R18 and R19 that is routed via a diode D13. The resistors R18 and R19 have a capacitor C5 provided in parallel with them.

A movement of the door 5 results in the capacitor C4 being charged via the resistor R16. At the same time, the capacitor is continually discharged via the resistor R17. On frequent and/or intensive movement of the door 5, the voltage on the first (positive) input of the threshold value switch IC2 exceeds the voltage on the second (negative) input of the threshold value switch IC2, as defined by the resistors R18 and R19, as a result of which the threshold value switch turns on the transistor T5. In this case, the capacitor C5 serves as a backup capacitor, so that the voltage on the second (negative) input is virtually constant. The time constant formed from C5, R18 and R19 may be much larger for this purpose than the time constant formed from C4 and R17.

In this state, the motor M is in turn shorted throughout the opening movement of the door 5 in practice (and not just after the door recoils from the closed position). This operating state is maintained until the capacitor C4 has discharged again sufficiently for the (lower) switching threshold of the threshold value switch IC2 to have been reached. Consequently, a falling switching edge is output at the output of the threshold value switch IC2, so that the transistor T5 is no longer actuated by the threshold value switch IC2. The electronic circuit 1i is then in the normal operating state again. The threshold value switch IC2 has a switching hysteresis to avoid unwanted oscillation phenomena. To this end, the output of the threshold value switch IC2 can provide feedback to the positive input of said threshold valve switch, for example in the form of a further resistor. In a further variant, it would also be conceivable for the capacitor C5 to be connected in parallel with the resistor R19 and with a zener diode (not shown), as a result of which the voltage threshold value has even better constancy.

At this juncture, it is noted that the third partial circuit 13 can alternatively or additionally also actuate the transistor T1. The comments in relation to FIGS. 9 and 10 can be applied mutatis mutandis.

It is also conceivable for the embodiments shown in FIGS. 9 to 11 to be combined. That is to say that the third partial circuit 13 bypasses the first switch S1, T1 and/or actuates it such that the resistance of the switch is lowered both when an opening movement of the door 5 occurs for a long time or frequently in an interval of time and when an overtemperature in the first switch S1, T1 is detected.

A third partial circuit 13 monitoring the intensity/frequency of a door movement is advantageous regardless of an ambient temperature of the rail vehicle 10 or of the door module 3. That is to say that protection against vandalism starts and protects the door module 3 against excessive mechanical loading even when the temperature of the transistor T1 is still a long way from a critical temperature on account of very low external temperatures. At very high ambient temperatures, on the other hand, a third partial circuit 13 monitoring the temperature of the transistor T1 is more likely to take effect, activating the protection against vandalism after just comparatively few instances of the door 5 being operated. A combination of the two measures accordingly pools the cited advantages. For the purpose of optimum protection, an OR combination of the two switching criteria is provided in this regard.

In general, it is also noted that there may be provision for the first switch S1 to be closed, or for the transistor T1 to be turned on, only sufficiently for the motor M to be able to produce a supply voltage that is necessary for the electronic circuit 1a . . . 1g. That is to say that the first switch S1 may also have a resistance far above zero even in the “closed” state. This can be accomplished in the example shown in FIG. 9 by applying an appropriate voltage to the base of the transistor T2. It would also be conceivable for the switch S1 or the transistor T2 to be actuated intermittently or in a pulsed manner and for the supply voltage for the electronic circuit 1a . . . 1g to be buffered, for example using a capacitor and/or a storage battery (not shown). The switch S1/the transistor T1 then changes essentially between the “open” and “closed” states, with the voltage that is necessary for supplying power to the electronic circuit 1a . . . 1g being produced on average. A further option is to provide a resistor R1 in the first path Z1, as is the case with the variant shown in FIG. 7. Finally, it is also conceivable for the supply of power for the electronic circuit 1a . . . 1g to be provided via a capacitor and/or a storage battery (not shown) that is charged during normal operation of the door module 3/of the rail vehicle 10 using the supply voltage U1. When the supply voltage U1 disappears, the storage battery/capacitor is accordingly discharged by the electronic circuit 1a . . . 1g.

In addition, it is noted that the measures disclosed in the application can be taken even when a supply voltage U1 is present. In particular, this relates to the braking of a movement of the door 5 in the direction of opening and to all resultant variants, for example intensified slowing of the door after it changes its direction of movement from a closing movement to an opening movement. When the supply voltage U1 is present, these tasks can, in principle, also be undertaken by control provided during normal operation. By way of example, the sequences presented may be mapped in software and performed during operation of the control. In this case, a movement of the door leaf 5 is not unavoidably evaluated using a voltage that the motor M produces by way of a generator, but rather can also be detected using a motion sensor, for example.

The exemplary embodiments show possible variant embodiments of an electronic circuit 1a . . . 1i according to the disclosed embodiments, of a door module 3 according to the disclosed embodiments and of a rail vehicle 10 according to the disclosed embodiments, and it will be noted at this juncture that the disclosed embodiments is not restricted to the specifically represented variant embodiments of these, but instead various combinations of the individual variant embodiments with one another are also possible and this opportunity for variation is within the ability of a person skilled in the art who is active in this technical field on account of the teaching with regard to the technical action by substantive disclosed embodiments. Thus, a11 conceivable variant embodiments that are possible by virtue of combination of individual details from the variant embodiment represented and described are also covered by the scope of protection.

In particular, it is recorded that an electronic circuit 1a . . . 1i, a door module 3 according to the disclosed embodiments and a rail vehicle 10 according to the disclosed embodiments may, in reality, also comprise more or fewer parts than shown.

As a matter of form, it will be pointed out in conclusion that as an aid to understanding the design of the door module 3 according to the disclosed embodiments and the rail vehicle 10 according to the disclosed embodiments, these and the parts thereof have sometimes been shown not to scale and/or in enlarged and/or reduced form.

The object on which the separate inventive solutions are based can be obtained from the description.

### LIST OF REFERENCE SYMBOLS

1,1a . . . 1i Electronic circuit
2 First partial circuit
3 Door module
4 Wall
5 Door leaf
6 Seal
7 Over-center locking system
8 Guide lever
9 Door rebate
10 Rail vehicle
11 Supply line
12 Second partial circuit
13 Third partial circuit
A1,A2 Motor connections
A3,A4 Supply connections
C1,C5 Capacitor
D1 . . . D12 Diode
IC1 Temperature switch
IC2 Threshold value switch
J1 Jumper
K1 Optocoupler
M Motor
R1 . . . R19 Resistor
S1,S2 Switch
T1 . . . T5 Transistor
U1 Supply voltage
Z1,Z2 Circuit path

1. An electronic circuit for a motor-driven door of a rail vehicle, the electronic circuit comprising:
motor connections for a drive motor of the door and supply connections for a supply voltage for the drive motor;
a first path connecting the motor connections, the first path comprising a first nonlinear element and a first controllable switch connected in series therewith, wherein the first nonlinear element is poled such that a resistance of the element to a current that the drive motor produces by way of a generator for a closing movement of the door is higher than for an opening movement, and
a first partial circuit, comprising the supply connections and connected to a control input of the first switch, that prompts an increase in the resistance of the first switch in response to the supply voltage being present in comparison with the resistance when the supply voltage is absent.

2. The electronic circuit of claim 1, wherein the first switch has a resistor arranged in parallel with it.

3. The electronic circuit of claim 1, further comprising a parallel path that is parallel to the first path and in which a linear element is arranged.

4. The electronic circuit of claim 1, further comprising a parallel path that is parallel to the first path and in which a second nonlinear element is connected in antiparallel with the first nonlinear element.

5. The electronic circuit of claim 3, wherein the path that is parallel to the first path has a second controllable switch arranged in the parallel path and the first partial circuit is connected to a control input of the second switch and prompts an increase in the resistance of the second switch in response to the supply voltage being present in comparison with the resistance when the supply voltage is absent.

6. The electronic circuit of claim 1, wherein the first partial circuit comprises a DC isolating element with an input side connected to the supply connections and has an output side connected to the control input of the first switch and controls input of the second switch.

7. The electronic circuit of claim 1, wherein the resistance acting in the first path and/or the path that is parallel thereto in the direction of opening and/or in the direction of closing of the door is adjustable.

8. The electronic circuit of claim 1, further comprising a second partial circuit that actuates the first switch such that the resistance of the switch immediately after the current turns from the closing movement of the door to the opening movement of the door is lower than afterwards.

9. The electronic circuit of claim 8, wherein the second partial circuit comprises a timer acting directly or indirectly on the control input of the first switch.

10. The electronic circuit of claim 8, further comprising by a third partial circuit that bypasses the first switch and/or actuates it such that the resistance of the switch is lowered when an opening movement of the door occurs for a long time or frequently in an interval of time.

11. The electronic circuit of claim 8, further comprising a third partial circuit that bypasses the first switch and/or actuates it such that the resistance of the switch is lowered for a rising temperature of the first switch.

12. A door module for a rail vehicle, the door module comprising:
a door;
a drive motor for the door; and
an electronic circuit comprising: motor connections for the drive motor of the door and supply connections for a supply voltage for the drive motor, a first path connecting the motor connections, the first path comprising a first nonlinear element and a first controllable switch connected in series therewith, wherein the first nonlinear element is poled such that a resistance of the element to a current that the drive motor produces by way of a generator for a closing movement of the door is higher than for an opening movement, and a first partial circuit, comprising the supply connections and connected to a control input of the first switch, that prompts an increase in the resistance of the first switch in response to the supply voltage being present in comparison with the resistance when the supply voltage is absent.

13. The door module as claimed in claim 12, wherein a linear element is provided instead of the first nonlinear element.

14. A rail vehicle comprising an electrical supply line, wherein a door module of claim 12 that is connected to the supply line.

15. The use of an electronic circuit of claim 1 in a door module of a rail vehicle.
